(19) United States
(12) Patent Application Publication
(10) Pub. No.: US 2015/0072179 A1
(43) Pub. Date: Mar. 12, 2015

(54) SEALED BATTERY

(71) Applicant: Toshiyuki Itabashi, Toyota-shi (JP)

(72) Inventor: Toshiyuki Itabashi, Toyota-shi (JP)

(21) Appl. No.: 14/373,709

(22) PCT Filed: Jan. 27, 2012
(86) PCT No.: PCT/JP2012/051800

§ 371 Date: Jul. 22, 2014

(51) Int. Cl. H01M 2/34; H01M 10/42

(52) U.S. Cl. CPC H01M 2/345; H01M 10/4235
USPC 429/7

(57) ABSTRACT

Disclosed is a sealed battery capable of suppressing time degradation of a CID. A battery (1) includes an electrode body (10), a case (20), and a CID (100) which interrupts a current in emergency. The CID (100) includes an inversion plate (110) which is transformed in association with an increase of a pressure in the case (20), and a collecting plate (120) which is connected to the inversion plate (110) and which is transformed in association with a transformation of the inversion plate (110). The collecting plate (120) has a carved part (123) formed in a groove, which is ruptured if the pressure in the case (20) is a predetermined value or more, and a plurality of slits (124). The plurality of slits (124) is arranged in the vicinity of the carved part (123), and is formed to open when the collecting plate (120) is transformed.

### TECHNICAL FIELD

The present invention relates to a sealed-type secondary battery having a current interrupt device for interrupting a current in emergency.

### BACKGROUND ART

Conventionally, a sealed-type secondary battery (hereinafter referred to as the “sealed battery”) is widely known, the sealed battery including an electrode body made by laminating and winding a pair of sheet-like electrodes (positive and negative electrodes) and separators interposed therebetween, and a case in which the electrode body and an electrolyte are stored.

In the sealed battery as mentioned above, in case of being in an overcharge condition, a gas resulting from a decomposition reaction of the electrolyte in the case causes an increase of the pressure in the case. This may cause a problem that the case is damaged for example.

In order to solve the above-mentioned problem, proposed is a sealed battery having a current interrupt device (hereinafter referred to as the “CID”) which interrupts a current if the pressure in the case is a predetermined value or more (for example, see Patent Literature 1).

The CID, for example, includes an inversion plate which is connected to an external terminal and which is transformed in association with an increase of the pressure in the case, and a collecting plate which is connected to the inversion plate and one electrode of the electrode body. In the CID, the collecting plate connected to the inversion plate is transformed in association with transformation of the inversion plate, and the collecting plate is ruptured if the collecting plate is subjected to stress of a predetermined value or more, thereby a current in the sealed battery being interrupted.

Recently, as a lifetime of the sealed battery is prolonged, there is growing concern about time degradation of the CID.

The time degradation of the CID is caused by variation of the pressure in the case associated with the use of the sealed battery. The pressure in the case increases and decreases repeatedly due to variation of temperature and the like. Thereby, the collecting plate is fatigued, and may be ruptured even if the pressure in the case does not reach a value required to rupture the collecting plate. In other words, a pressure (the pressure in the case) required to run the CID becomes lower.

Since the CID acts as a safeguard, long-term operation guarantee is required for the CID.

Therefore, in the sealed battery having the CID, it is greatly expected that the time degradation of the CID is suppressed.

### CITATION LIST

### Patent Literature

Patent Literature 1: WO 2010/053100 A1

### SUMMARY OF INVENTION

### Problem to be Solved by the Invention

The objective of the present invention is to provide a sealed battery capable of suppressing time degradation of a CID.

### Means for Solving the Problem

A first aspect of the invention is a sealed battery including an electrode body which is impregnated with an electrolyte to function as a power generation element, a case in which the electrode body and the electrolyte are stored, and a current interrupt device which interrupts a current in emergency. The current interrupt device includes an inversion plate which is transformed in association with an increase of a pressure in the case, and a collecting plate having a pair of plate surfaces, which is connected to the inversion plate and which is transformed in association with a transformation of the inversion plate. The collecting plate has a carved part formed in a groove, which is ruptured if the pressure in the case is a predetermined value or more, and a plurality of slits which is formed to penetrate through the pair of plate surfaces. The plurality of slits is arranged in the vicinity of the carved part, and is formed to open when the collecting plate is transformed.

Preferably, the plurality of slits is formed to intersect with the carved part.

Preferably, each of the plurality of slits is linearly formed, and is arranged to be perpendicular to the carved part.

Preferably, the carved part is formed in a perfect circle, and the plurality of slits is radially arranged at equal intervals.

Preferably, the collecting plate has a thin part which is formed around a part, connected to the inversion plate, of the collecting plate, and which has a thickness smaller than that of the other part of the collecting plate, the carved part and the plurality of slits are arranged in the thin part, and the thin part is curved in a wavy shape from the middle to the outer edge thereof.

### Effects of the Invention

The present invention makes it possible to suppress time degradation of a CID.

### BRIEF DESCRIPTION OF DRAWINGS

FIG. 1 shows a sealed battery according to an embodiment of the present invention.

FIG. 2 shows a thin part of a collecting plate, in which FIG. 2(a) is a sectional side end view thereof, and FIG. 2(b) is a bottom view thereof.

FIG. 3 shows how the thin part of the collecting plate is transformed.

FIG. 4 shows how slits formed in the thin part of the collecting plate open.

FIG. 5 is a schematic view showing how a conventional thin part is transformed.

FIG. 6 is a schematic view showing how the thin part according to the embodiment of the present invention is transformed, in which FIG. 6(a) is a side view, and FIG. 6(b) is a plan view.

FIG. 7 shows results obtained by analyzing stress generated on a carved part of the thin part by means of CAE.

FIG. 8 shows a thin part of a collecting plate according to another embodiment of the present invention.

FIG. 9 shows a thin part of a collecting plate according to another embodiment of the present invention.

FIG. 10 shows a thin part of a collecting plate according to another embodiment of the present invention.

### DESCRIPTION OF EMBODIMENTS

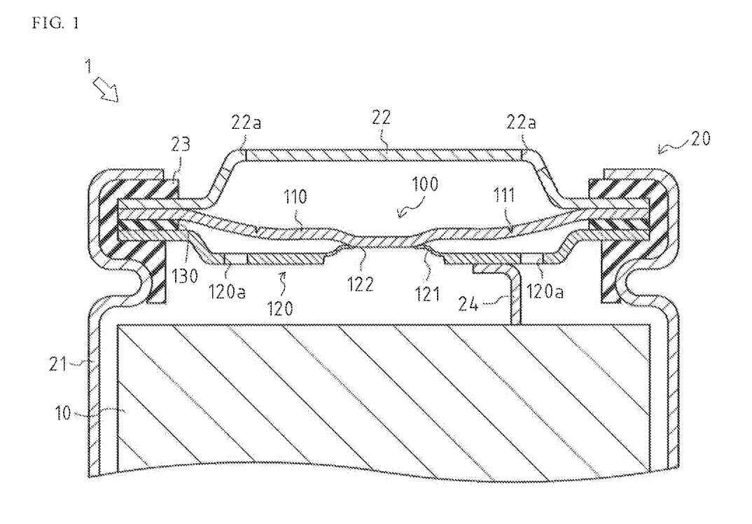

With reference to FIGS. 1 to 4, described below is a battery 1 as an embodiment of a sealed battery according to the present invention.

The battery 1 is what is called a cylindrical battery.

For convenience, a top-bottom direction in FIG. 1 is defined as a top-bottom direction of the battery 1.

Moreover, in the following description, an upper side and a lower side generally mean the outer side and the inner side of the battery 1, respectively.

As shown in FIG. 1, the battery 1 is a sealed-type secondary battery, and includes an electrode body 10 which is impregnated with an electrolyte to function as a power generation element, a case 20 in which the electrode body 10 and the electrolyte are stored, and a CID 100 which interrupts a current in emergency.

The electrode body 10 is made by laminating and cylindrically winding a pair of sheet-like electrodes (positive and negative electrodes) and separators interposed therebetween. The electrode body 10 acts as a power generation element when being impregnated with the electrolyte.

The case 20 is a substantially cylindrical member forming an exterior of the battery 1.

The case 20 includes a storage part 21, and a lid part 22.

The storage part 21 is a bottomed cylindrical member whose top end is open, and is made of an electrically conductive material such as aluminum or iron. Inside the storage part 21, the electrode body 10 and the electrolyte are stored. The bottom part (lower end part) of the storage part 21 is electrically connected to the negative electrode of the electrode body 10 through a negative-electrode collecting member with electrical conductivity (not shown). The storage part 21 acts as a negative electrode terminal of the battery 1.

The lid part 22 is a substantially disk-like member for closing the opening of the storage part 21, and is made of an electrically conductive material such as aluminum or iron. The lid part 22 is arranged to cover the opening of the storage part 21. The upper end part of the storage part 21 and the outer circumferential part of the lid part 22 are fixed to each other through an insulative gasket 23. The central part of the lid part 22 upward protrudes. The lid part 22 is electrically connected to the positive electrode of the electrode body 10 through a positive-electrode lead 24 with electrical conductivity, and members (specifically, an after-mentioned inversion plate 110 and an after-mentioned collecting plate 120) constituting the CID 100. The lid part 22 acts as a positive electrode terminal of the battery 1.

The lid part 22 has a plurality of vents 22a penetrating through both the plate surfaces thereof.

Therefore, the space in the storage part 21 is not sealed by the lid part 22. In other words, the plurality of vents 22a provides communication between the inside and the outside of the case 20.

The CID 100 is a current interrupt device which interrupts a current if the battery 1 is in an overcharge condition and a pressure in the case 20 of abnormally increases.

The CID 100 includes the inversion plate 110 and the collecting plate 120.

The inversion plate 110 and the collecting plate 120 are substantially disk-like members with electrical conductivity. An insulator 130 is interposed between the inversion plate 110 and the collecting plate 120.

The insulator 130 is an annular member with electrical insulation property. The insulator 130 is configured to come in contact with the outer circumferential part of the inversion plate 110 and the outer circumferential part of the collecting plate 120. Thus, the insulator 130 interrupts electrical conduction between the outer circumferential part of the inversion plate 110 and the outer circumferential part of the collecting plate 120.

The inversion plate 110 and the collecting plate 120 are, similarly to the lid part 22 of the case 20, fixed to the storage part 21 of the case 20 through the gasket 23.

Specifically, the lid part 22, the inversion plate 110, the insulator 130 and the collecting plate 120 are concentrically laminated from above in the order mentioned, and are fixed in the upper end part of the storage part 21 with the outer circumferential parts of these members grasped by the gasket 23. Thus, the outer circumferential parts of the lid part 22 and the inversion plate 110 are electrically connected to each other, and the gasket 23 interrupts electrical conduction between the storage part 21, and the lid part 22, the inversion plate 110 and the collecting plate 120.

The inversion plate 110 is a member for forming an enclosed space inside the case 20. The inversion plate 110 is formed to gradually come into proximity with the collecting plate 120 (to gradually dent downward) toward the central part thereof.

As mentioned previously, since the lid part 22 has the plurality of vents 22a, the lid part 22 cannot form the enclosed space inside the case 20. However, since the inversion plate 110 is arranged below the lid part 22 so as to close the opening of the storage part 21, the inversion plate 110 forms the enclosed space inside the case 20.

A carved part 111 in the shape of a groove is formed on the upper surface of the inversion plate 110.

The carved part 111 is formed in such a manner that the upper surface of the inversion plate 110 is downward carved, and is continuously formed in a circumferential direction of the inversion plate 110. In other words, the carved part 111 is formed in a continuous circle on the upper surface of the inversion plate 110, and is arranged concentrically with the inversion plate 110.

The collecting plate 120 is electrically connected to the positive electrode of the electrode body 10 through the positive-electrode lead 24.

Specifically, one end of the positive-electrode lead 24 is connected to the lower surface of the collecting plate 120, and the other end of the positive-electrode lead 24 is connected to the positive electrode of the electrode body 10.

A thin part 121 whose thickness (distance between the surface of the collecting plate 120 facing to the electrode body 10 and the opposite surface thereof) is smaller than that of the other part of the collecting plate 120 is formed in the central part of the collecting plate 120.

The thin part 121 is formed around the part of the collecting plate 120 connected to the inversion plate 110. Specifically, the thin part 121 is formed from the part of the collecting plate 120 connected to the inversion plate 110 toward the middle part of the collecting plate 120 in a radial direction thereof. The thin part 121 is formed in substantially a disk, and is arranged concentrically with the collecting plate 120.

Details for structure of the thin part 121 are described later.

A fitting hole 122 penetrating through both the plate surfaces of the thin part 121 in the top-bottom direction is formed in the central part of the thin part 121.

The fitting hole 122 is a through hole in which the central part of the inversion plate 110 is fit.

The part of the inversion plate 110 in contact with the thin part 121 of the collecting plate 120, and the part of the thin part 121 in contact with the inversion plate 110 are joined by means of welding or the like with the central part of the inversion plate 110 fit in the fitting hole 122. Thereby, the inversion plate 110 and the collecting plate 120 are electrically connected to each other, and consequently the lid part 22 and the positive electrode of the electrode body 10 are electrically connected to each other.

Thus, the collecting plate 120 is connected to the inversion plate 110 in the vicinity of the center of the collecting plate 120. Moreover, as mentioned previously, the outer circumferential part of the collecting plate 120 is separated from the outer circumferential part of the inversion plate 110 by the insulator 130.

Therefore, a predetermined space is formed between the inversion plate 110 and the collecting plate 120.

A plurality of communicating holes 120a is formed in the part of the collecting plate 120 situated radially outward of the thin part 121.

The plurality of communicating holes 120a is formed to penetrate through both the plate surfaces of the collecting plate 120 in the top-bottom direction.

Therefore, if a gas results from a decomposition reaction of the electrolyte in the space below the collecting plate 120, the gas enters the space between the inversion plate 110 and the collecting plate 120 through the plurality of communicating holes 120a.

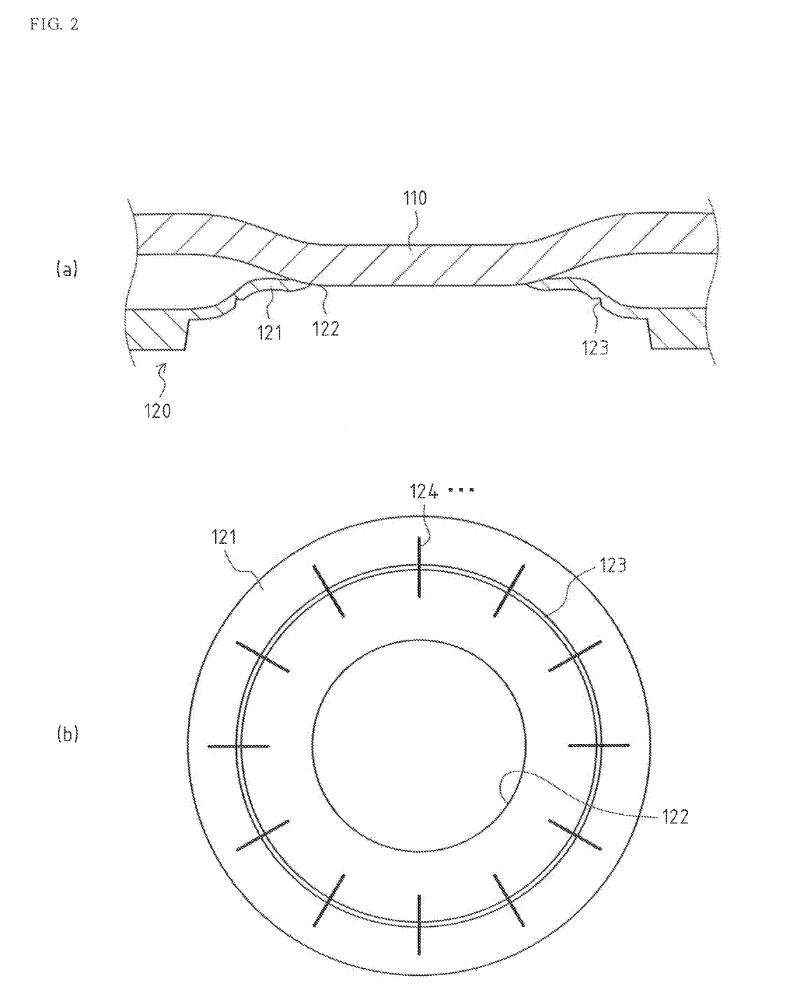

As shown in FIGS. 2(a) and 2(b), the thin part 121 is formed in a perfect circle, and is formed from the fitting hole 122 toward the middle part of the collecting plate 120 in the radial direction. A carved part 123 in the shape of a groove is formed on the surface of the thin part 121 facing to the electrode body 10.

The carved part 123 is substantially similar in configuration to the carved part 111 of the inversion plate 110, and is formed in such a manner that the surface of the thin part 121 facing to the electrode body 10 is carved. The carved part 123 is continuously formed in the circumferential direction of the thin part 121, and is arranged concentrically with the thin part 121. In other words, the carved part 123 is formed in a perfect circle.

In FIG. 2(b), for convenience, the parts of the collecting plate 120 other than the thin part 121 are omitted.

As shown in FIG. 2(a), the thin part 121 is curved in a wavy shape from the central part to the outer circumferential part thereof.

Specifically, the thin part 121 is curved in the top-bottom direction from the central part to the outer circumferential part thereof, and is formed so that all the shapes of the cutting surfaces thereof along the radial direction are substantially same. In other words, the thin part 121 has a shape in which an annular plate is bent along the radial direction. The thin part 121 having such a shape may be formed by means of press working or the like.

As shown in FIG. 2(b), the thin part 121 has a plurality of slits 124 (twelve slits 124 in the present embodiment).

The plurality of slits 124 is radially arranged at equal intervals around the fitting hole 122.

The slit 124 penetrates through both the plate surfaces of the thin part 121, and is linearly formed from the vicinity of the fitting hole 122 of the thin part 121 to the vicinity of the outer circumferential part of the thin part 121. The slit 124 is formed to intersect with the carved part 123, and to be perpendicular to the carved part 123. In other words, the slit 124 is formed in the radial direction of the thin part 121 so as to perpendicularly intersect with the carved part 123.

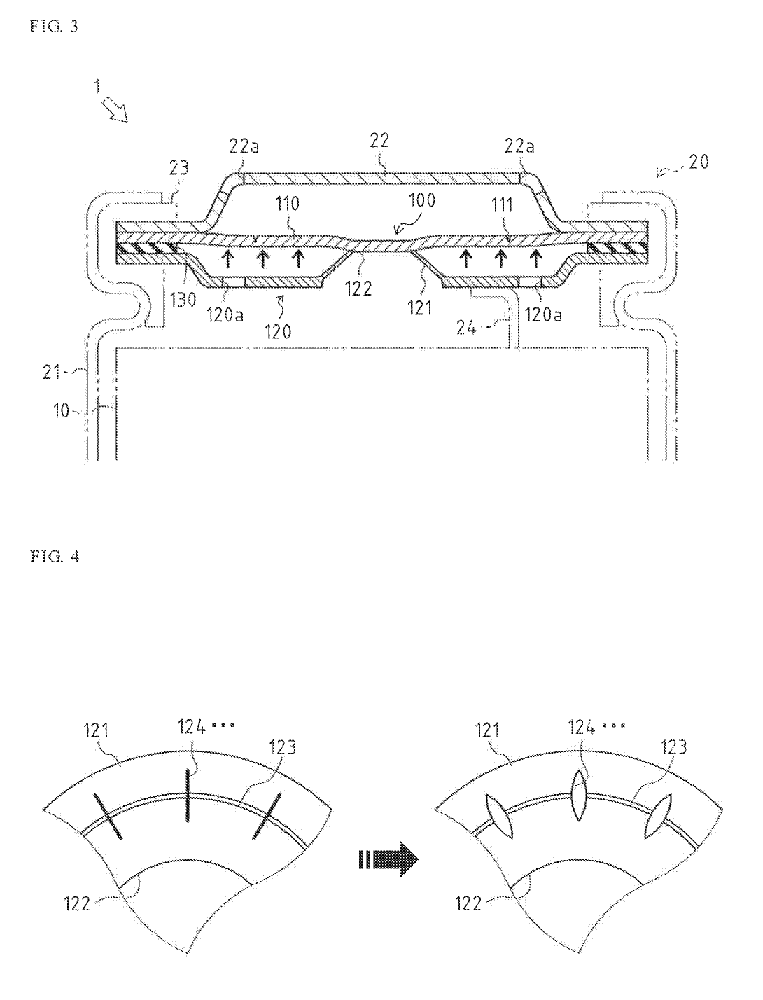

As shown in FIG. 3, if the pressure in the case 20 (specifically, the pressure in the space between the storage part 21 and the inversion plate 110) is increased by the gas resulting from a decomposition reaction of the electrolyte, the gas enters the space between the inversion plate 110 and the collecting plate 120 through the plurality of communicating holes 120a of the collecting plate 120, and thereby the inversion plate 110 is upward pressed and transformed. Consequently, the part, connected to the inversion plate 110, of the thin part 121 of the collecting plate 120 is upward pulled, and the thin part 121 is transformed.

At this time, as shown in FIG. 4, the plurality of slits 124 formed in the thin part 121 opens in association with transformation of the thin part 121.

This makes it possible to suppress interfering with circumferential transformation of the thin part 121, and to reduce stress generated on the carved part 123 of the thin part 121.

Therefore, it is possible to minimize fatigue of the carved part 123 which is to be accumulated in the case where the pressure in the case 20 increases and decreases at a relatively low level due to variation of temperature of the battery 1 in use, and the like. Consequently, it is possible to suppress time degradation of the CID 100.

Moreover, as shown in FIG. 3, if the pressure in the case 20 increases, and the part, connected to the inversion plate 110, of the thin part 121 of the collecting plate 120 is upward pulled, the wavy part of the thin part 121 is stretched. In other words, since the thin part 121 is curved in a wavy shape (see FIG. 2(a)), the curved part thereof is stretched and transformed if the part, connected to the inversion plate 110, of the thin part 121 of the collecting plate 120 is upward pulled in association with an increase of the pressure in the case 20.

This makes it possible to reduce stress which is generated on the thin part 121 if the part, connected to the inversion plate 110, of the thin part 121 of the collecting plate 120 is upward pulled in association with the increase of the pressure in the case 20. Specifically, even if the part, connected to the inversion plate 110, of the thin part 121 of the collecting plate 120 is upward pulled in association with the increase of the pressure in the case 20, the thin part 121 is not subjected to relatively large stress as long as the wavy part of the thin part 121 is not completely stretched. Thus, the stress generated on the thin part 121 can be reduced.

Therefore, it is possible to minimize fatigue of the carved part 123 which is accumulated in the case where the pressure in the case 20 increases and decreases at a relatively low level due to variation of temperature of the battery 1 in use, and the like. Consequently, it is possible to suppress time degradation of the CID 100.

If the pressure in the case 20 further increases, and the carved part 123 of the thin part 121 is subjected to stress of a predetermined value or more, the carved part 123 is ruptured. Thereby, electrical conduction between the inversion plate 110 and the collecting plate 120 is interrupted, and consequently a current in the battery 1 is interrupted.

If the pressure in the case 20 much further increases, the inversion plate 110 is further upward pulled, and the carved part 111 of the inversion plate 110 is ruptured. Thereby, communication between the spaces above and below the inversion plate 110 in the case 20 is provided, and the gas resulting from a decomposition reaction of the electrolyte is discharged to the outside of the case 20 through the plurality of vents 22a of the lid part 22.

This makes it possible to prevent the case 20 from breaking if the gas resulting from a decomposition reaction of the electrolyte increases the pressure in the case 20.

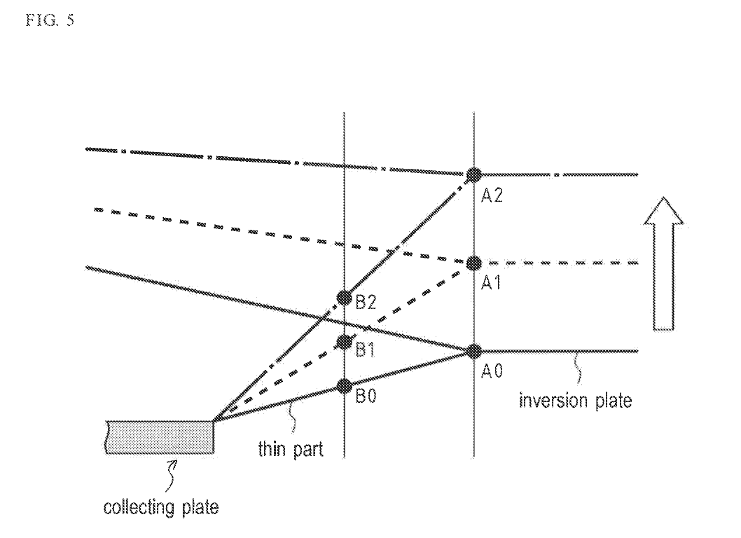

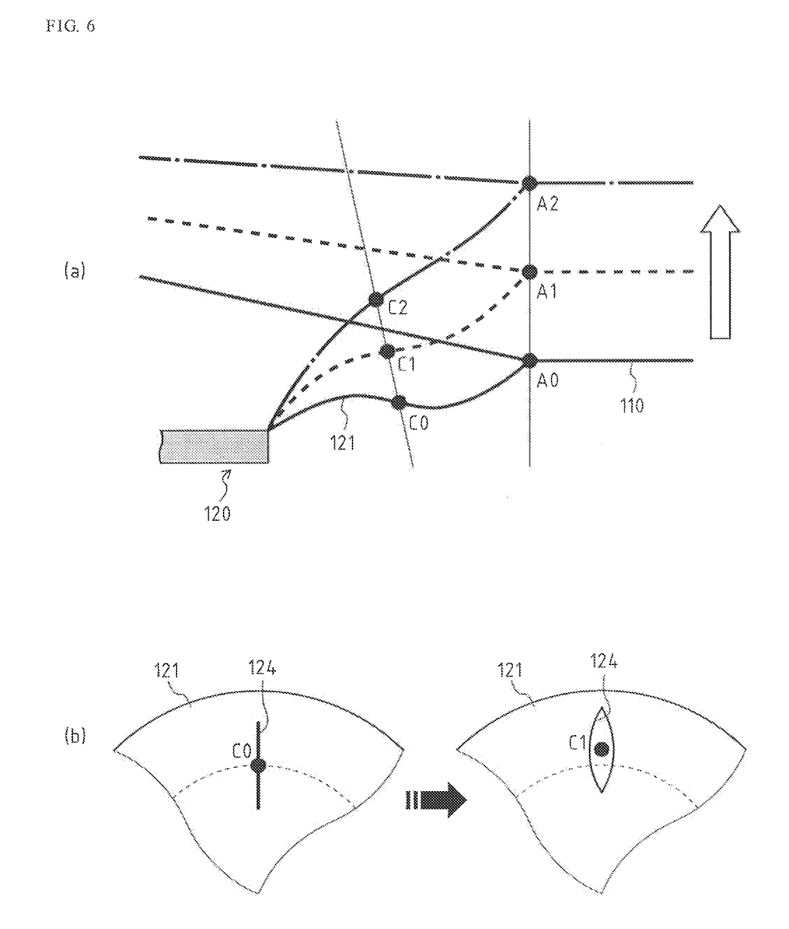

With reference to FIGS. 5 and 6, described below is how the thin part 121 of the collecting plate 120 is transformed if the pressure in the case 20 increases.

FIG. 5 is a schematic view showing how a conventional thin part in which the plurality of slits 124 is not formed and which is not curved in a wavy shape (is formed in a flat plate) is transformed.

FIG. 6 is a schematic view showing how the thin part 121 according to an embodiment of the present invention is transformed.

In FIGS. 5 and 6, a point at which the inversion plate and the thin part of the collecting plate are connected to each other is indicated by A, and in the order of time series, A0, A1 and A2 are illustrated.

Moreover, any point on the conventional thin part is indicated by B, and in the order of time series, B0, B1 and B2 are illustrated.

Moreover, any point on the thin part 121 is indicated by C, and in the order of time series, C0, C1 and C2 are illustrated.

As shown in FIG. 5, in the conventional thin part, the locus of the point A and the locus of the point B are substantially parallel.

In order for the point B to move nonparallel to the locus of the point A, the distance (radial length) from the center of the thin part to the point B needs to change, and the circumferential length of the thin part at the point B needs to change. Realizing this needs a large amount of energy.

In general, since transformation makes progress so that energy therefor is a minimum, the conventional thin part is transformed so that the locus of the point A and the locus of the point B are substantially parallel.

As shown in FIGS. 6(a) and 6(b), in the thin part 121 according to an embodiment of the present invention, the opening and closing of the plurality of slits 124 formed in the thin part 121 absorb circumferential distortion of the thin part 121, and thereby the point C can move radially outward of the thin part 121. In other words, the opening and closing of the plurality of slits 124 formed in the thin part 121 change the circumferential length of the thin part 121 at the point C, and change the distance (radial length) from the center of the thin part 121 to the point C.

This makes it possible to, when the thin part 121 is transformed, easily stretch the wavy part thereof, and to greatly reduce the stress generated on.

Therefore, it is possible to greatly suppress fatigue of the carved part 123 of the thin part 121 which is to be accumulated in the case where the pressure in the case 20 increases and decreases at a relatively low level due to variation of temperature of the battery 1 in use, and the like. Consequently, it is possible to greatly suppress time degradation of the CID 100.

In FIG. 7, shown are results obtained by analyzing, by means of CAE, the stress generated on the carved part 123 of the thin part 121 according to an embodiment of the present invention, and the stress generated on the conventional carved part of the thin part.

FIG. 7 shows a relationship between the pressure in the case of the battery and the stress generated on the carved part of the thin part.

As shown in FIG. 7, in the case where the pressure in the case of the battery is a predetermined value (P in FIG. 7) before the carved part of the thin part is ruptured, the stress generated on the carved part 123 of the thin part 121 according to an embodiment of the present invention is smaller than the stress generated on the conventional carved part of the thin part.

Therefore, it was found that the thin part 121 according to an embodiment of the present invention could reduce the stress generated on the carved part 123.

In the present embodiment, the thin part 121 has the carved part 123 continuously formed in the circumferential direction thereof, but a configuration of the thin part 121 is not limited thereto.

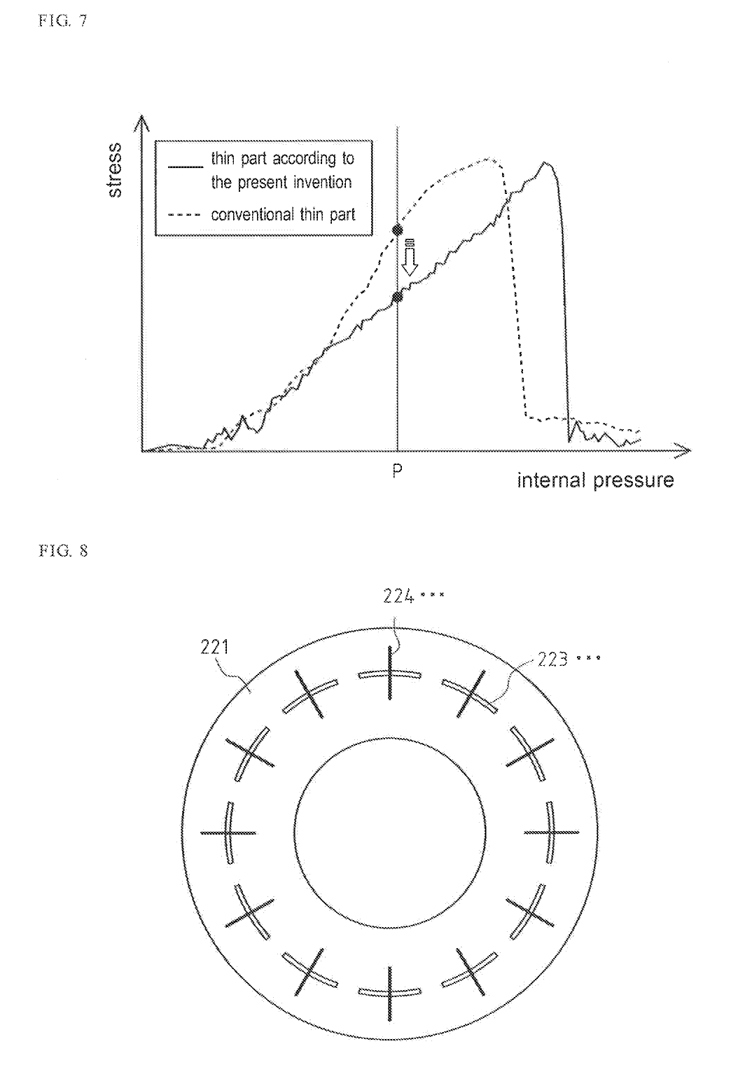

For example, as shown in FIG. 8, a thin part 221 in which a plurality of carved parts 223 is intermittently formed may be used as a thin part according to an embodiment of the present invention.

In this case, it is preferable that the same number of slits 224 as the plurality of carved parts 223 are formed, and are arranged to perpendicularly intersect with the respective carved parts 223.

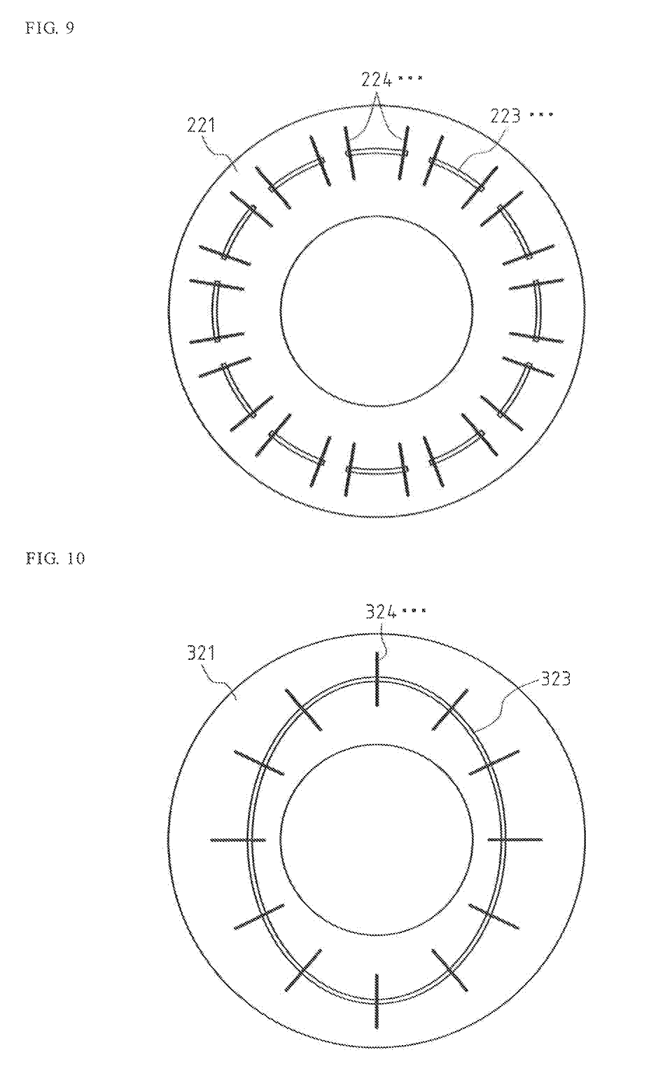

It is more preferable that, as shown in FIG. 9, a pair of slits 224 is formed in the vicinities of both ends of each carved part 223, and each pair of slits 224 is arranged to perpendicularly intersect with each carved part 223.

This makes it possible to inhibit stress from being unevenly generated on the thin part 221 due to difference between rigidity of the part, on which the carved parts 223 is formed, of the thin part 221, and rigidity of the part, on which the carved parts 223 is not formed, of the thin part 221. Specifically, cracks are formed so as to connect the adjacent carved parts 223 when each slit 224 opens, thus enabling to bring the rigidity of the part, on which the carved parts 223 is not formed, of the thin part 221 close to the rigidity of the part thereof on which the carved parts 223 is formed, and to even the stress on the thin part 221.

Moreover, in the present embodiment, the thin part 121 has the carved part 123 in the shape of a perfect circle, but a configuration of the thin part 121 is not limited thereto.

For example, as shown in FIG. 10, a thin part 321 having a carved part 323 in the shape of an ellipse may be used as a thin part according to an embodiment of the present invention. In this case, it is preferable that a plurality of slits 324 is formed to perpendicularly intersect with the carved part 323.

In the present embodiment, the twelve slits 124 are formed in the thin part 121. However, the number of the slits 124 is not limited thereto, and is set to a suitable number for reducing the stress generated on the carved part 123 of the thin part 121.

Moreover, in the present embodiment, the slits 124 are formed to intersect with the carved part 123, but may be formed not to intersect with the carved part 123 as long as the slits 124 are arranged in the vicinity of the carved part 123.

However, in order to suitably reduce the stress generated on the carved part 123 of the thin part 121, it is preferable that the slits 124 are formed to intersect with the carved part 123.

Moreover, in the present embodiment, the slits 124 are formed to be perpendicular to the carved part 123, but may be formed not to be perpendicular to the carved part 123.

However, in order to suitably reduce the stress generated on the carved part 123 of the thin part 121, it is preferable that the slits 124 are formed to be perpendicular to the carved part 123.

Moreover, in the present embodiment, the plurality of slits 124 is radially arranged at equal intervals, but a configuration of the plurality of slits 124 is not limited thereto.

However, in view of removing unevenness of the stress generated on the carved part 123 of the thin part 121, it is preferable that the plurality of slits 124 is radially arranged at equal intervals.

Moreover, in the present embodiment, each of the slit 124 is formed in a straight line. However, each of the slit 124 may be formed in a curved line as long as the plurality of slits 124 can open to reduce the stress generated on the carved part 123 of the thin part 121.

In the present embodiment, the battery 1 is a cylindrical battery, but a square battery may be used as a sealed battery according to an embodiment of the present invention.

### INDUSTRIAL APPLICABILITY

The present invention is applied to a sealed-type secondary battery having a current interrupt device for interrupting a current in emergency.

### REFERENCE SIGNS LIST

1: battery
10: electrode body
20: case
21: storage part
22: lid part
100: CID
110: inversion plate
111: carved part
120: collecting plate
121: thin part
122: fitting hole
123: carved part
124: slit

1. A sealed battery comprising:
an electrode body which is impregnated with an electrolyte to function as a power generation element;
a case in which the electrode body and the electrolyte are stored; and
a current interrupt device which interrupts a current in emergency,
wherein the current interrupt device includes an inversion plate which is transformed in association with an increase of a pressure in the case, and a collecting plate having a pair of plate surfaces, which is connected to the inversion plate and which is transformed in association with a transformation of the inversion plate,
the collecting plate has a carved part formed in a groove, which is ruptured if the pressure in the case is a predetermined value or more, and a plurality of slits which is formed to penetrate through the pair of plate surfaces, and
the plurality of slits is arranged in the vicinity of the carved part, and is formed to open when the collecting plate is transformed.

2. The sealed battery according to claim 1, wherein
the plurality of slits is formed to intersect with the carved part.

3. The sealed battery according to claim 1, wherein
each of the plurality of slits is linearly formed, and is arranged to be perpendicular to the carved part.

4. The sealed battery according to claim 3, wherein
the carved part is formed in a perfect circle, and
the plurality of slits is radially arranged at equal intervals.

5. The sealed battery according to claim 1, wherein
the collecting plate has a thin part which is formed around a part, connected to the inversion plate, of the collecting plate, and which has a thickness smaller than that of the other part of the collecting plate,
the carved part and the plurality of slits are arranged in the thin part, and
the thin part is curved in a wavy shape from the middle to the outer edge thereof.
